(19) United States
(12) Patent Application Publication
(10) Pub. No.: US 2012/0034524 A1
(43) Pub. Date: Feb. 9, 2012

(54) Nano-Composite Anode for High Capacity Batteries and Methods of Forming Same

(75) Inventors: Robert Caracciolo, Lancaster, PA (US); Youssef M. Habib, Lancaster, PA (US)

(73) Assignee: ILLUMINEX CORPORATION, Lancaster, PA (US)

(21) Appl. No.: 13/016,845

(22) Filed: Jan. 28, 2011

Related U.S. Application Data
(63) Continuation of application No. 12/777,165, filed on May 10, 2010.
(60) Provisional application No. 61/299,749, filed on Jan. 29, 2010.

(51) Int. Cl. H01M 4/38; H01M 4/88; C01B 33/02; H01M 4/02; B05D 5/12; B82Y 30/00

(52) U.S. Cl. 429/219; 429/209; 429/220; 429/218.1; 429/221; 429/231.5; 429/223; 429/229; 429/225; 427/123; 252/182.1; 423/348; 977/762; 977/755

(57) ABSTRACT

A battery anode comprised of metallic nanowire arrays is disclosed. In one embodiment the lithium battery uses Silicon nanowires or another element that alloy with Lithium or another element to produce high capacity lithium battery anodes.

### PRIORITY CLAIM

This application claims priority as a non-provisional continuation of U.S. Provisional Patent Application No. 61/299,749 filed on Jan. 29, 2010 which is herein incorporated by reference. This application claims priority as a continuation to U.S. patent application Ser. No. 12/777,165 filed on May 10, 2010 which is herein incorporated by reference.

### BACKGROUND OF THE INVENTION

Lithium-ion is the battery chemistry of choice for powering future generations of portable electronics and hybrid and plug-in hybrid electric vehicles (EV), alternative power storage for grid back-up and point-of-use, and many military applications. For example, an EV battery will require high energy density, approximately 200 Wh/kg, high cycle-life, >1000 charge-discharge cycles, ease of maintenance, environmentally friendly, economic, and safe. The battery industry seeks the development of advanced battery chemistries, architectures, and manufacturing processes that can support the above goals. The present invention is a novel nano-composite Cu—Si anode for high-performance LIB and other energy storage applications.

Silicon (Si) is one of the most promising Lithium-Ion Battery (LIB) anode materials because its theoretical mass specific capacity (see: J. Lee, W. Kim, J. Kim, S. Lim, and S. Lee. Journal of Power Sources 176 [2008] 353-358; L. F. Cui, R. Ruffo, C. K. Chan, and Y. Cui, NanoLetters, 9, 491-495 [2009]; L. F. Cui, Y. Yang, C. M. Hsu, and Y. Cui, NanoLetters, 9, 3370-3374 [2009]); W. Xu and J. C. Flake, J. Electrochem. Soc. 157(1) A41-A45 [2010]), 4,200 Ah/kg, is much higher than any material in use today. Current industry dominant graphite anodes which have a theoretical mass specific capacity (see: D. Linden and T. Reddy. Handbook of Batteries [3^{rd} Edition]) of 372 Ah/kg. Although Si has such high specific capacity, current designs suffer from strain related structural failures that have so far prevented the practical and broad implementation of this highly promising material. Si expands as much as 400% upon saturation with Li.

### PRIOR ART

To circumvent the high strain problem, several approaches to Si anode fabrication have been studied, the most significant of which have been thin films. The following references are herein incorporated by reference: Si nanowires and silicon-carbon nanocomposites: J. Lee, W. Kim, J. Kim, S. Lim, and S. Lee. Journal of Power Sources 176 [2008] 353-358; I. Younezu, H. Tarui, S. Yoshimura, S. Fujitani, and T. Nohm, SANYO Electric Co., Ltd., Abs. 58, IMLB12 Metting, © 2004 The Electrochemical Society, Inc.; D. Yu, Y. Xing, Q. Hang, H. Yan, J. Xu, Z. Xi, and S. Feng, Physica E 9 [2001] 305-309; H. Yang, P. Fu, H. Zhang, Y. Song, Z. Zhou, M. Wu, L. Huang, and G. Xu, Journal of Power Sources 174 [2007] 533-537; L. F. Cui, R. Ruffo, C. K. Chan, and Y. Cui, NanoLetters, 9, 491-495 [2009], L. F. Cui, Y. Yang, C. M. Hsu, and Y. Cui, NanoLetters, 9, 3370-3374 [2009]); W. Xu and J. C. Flake, J. Electrochem. Soc. 157(1) A41-A45 [2010]). Xu et al provides a comprehensive review of several studies performed on Si thin films as the active material for Li-ion Cells (the following reference is incorporated by reference: H. Yang, P. Fu, H. Zhang, Y. Song, Z. Zhou, M. Wu, L. Huang, and G. Xu, Journal of Power Sources 174 [2007] 533-537). The highest capacities, >3000 Ah/kg, were observed with films <250 nm thick, and showed no signs of degradation up to 70 charge-discharge cycles. Yang et al produced an anode comprised of a 2000 nm thick amorphous Si (α-Si) film deposited on a Cu foil and reported structural and electrical stability for greater than 300 charge-discharge cycles at 1180 Ah/kg when tested in a full-cell format against a LiCoO₂ cathode (see: H. Yang, P. Fu, H. Zhang, Y. Song, Z. Zhou, M. Wu, L. Huang, and G. Xu, Journal of Power Sources 174 [2007] 533-537). Although such high specific capacities were observed, thin films combined with the necessary electrical conductor, i.e. Cu foil, cannot meet the half-cell Volumetric Energy Density goals of 600 Wh/liter and/or Specific Energy Density of 400 Wh/kg. Energy Density is defined in Detailed Descriptions of the Preferred Embodiments.

Si structures with nanometer scale dimensions do not experience the high strain that bulk Si structures do, due to homogeneous expansion and ductility and have exhibited improvements in the performance of Si-based anodes (see: Investigating Nanopillars: Silicon Brittle? Not This Kind!, http://www.sciencedaily/2009/10/09100833455.htm). Also nanostructured Si anodes provide other advantages relative to transport kinetics of Li for the insertion/extraction process, and room for the Si to expand as it is alloys with Li. Cui et al demonstrated anodes comprised of SiNW arrays grown by a Vapor-Liquid-Solid (VLS) process on a stainless steel substrate were able to accommodate large strain without mechanical degradation (see: L. F. Cui, R. Ruffo, C. K. Chan, and Y. Cui, NanoLetters, 9, 491-495 [2009] which is incorporated herein by reference). The SiNW arrays also exhibited high charge storage capacity (>1000 Ah/kg, 3 times of carbon) maintaining 90% capacity retention as it approached 100 cycles, but with signs of degradation. Cui et al further demonstrated anodes comprised of carbon nanofibers coated with conformal α-Si films, and reported similar performance as the SINW (see: L. F. Cui, Y. Yang, C. M. Hsu, and Y. Cui, NanoLetters, 9, 3370-3374 [2009]). Additional approaches of combining Si with nanoparticles such as carbon nanotubes also exhibit promising performance (see: W. Wang, P. N. Kumta, J. Power Sources 172 [1007] 650). However it has also been reported that nanometer-sized Si particles in composites tend to agglomerate after the insertion/extraction of Li ions, compromising the various advantages afforded by the nanostructure (see: H. Li, X. Huang, L. Chen, G. Zhou, Z. Zhang, D. You, Y. J. Mo, N. Pei, Solid-State Ionics 135 [2000] 181; R. Teki, M. K. Data, R. Krishnana, T. C. Parker, T-M Lu, P. N. Kumta, and N. Koratkar, Small, 1-7 [2009]).

### SUMMARY OF THE INVENTION

The Illuminex Corporation innovation is a unique Copper-Silicon-NanoComposite (CSNC) design comprised of a nano-structured Cu foil (sheet of copper covered with vertically aligned copper nanowires (CuNW) in an array) with a Silicon film, 10 nm-300 μm thick deposited over the surface. A Cu foil with a CuNW array on the surface has surface area enhanced 200 to 10,000 times compared to a planar Cu foil: Thus, a given thickness of Si on NW array will contain a higher volume than the same given thickness of Si on a planar surface. In such a configuration, the Volumetric Cell Capacity is 5 to 10 times than that of the 600 Wh/liter goal.

FIG. 1 shows examples of CuNW arrays with high and low NW (nanowire) spacing and diameters. As explained in detail in Detailed Descriptions of the Preferred Embodiments Illuminex can produce arrays with the following range of specifications: NW dia (diameters) approximately 2-900 nm, C-C distance approximately 50-980 nm, NW length approximately 0.1-100 microns. A square cm of Cu foil with a CuNW array can possess 1 to 10 billion NW's each with a surface area of 50 to 300 billionths of a square cm resulting in a total surface area of 50 to 3000 square cm. One square centimeter of Cu foil can possess as much as 3000 square cm's of NW surface area. The total surface area of the NW array is essentially the surface area of each NW times the number of NW's. The Surface Area Enhancement is defined as the Total Surface Area of the CuNW array divided by the Planar Area of the Cu substrate. CuNW array is disclosed in U.S. patent application Ser. No. 11/206,632 filed on Aug. 15, 2005, and PCT/US07/63337 both of which are incorporated by reference. In addition is the relevant device disclosed in U.S. Provisional Patent Application No. 60/778,873 filed on Mar. 3, 2006, U.S. Provisional Patent Application No. 60/888,391 filed on Feb. 6, 2007 and U.S. patent application Ser. No. 12/281,511 filed on Sep. 3, 2008 all of which are incorporated by reference. The substrate base material or NW array is not limited to Cu, but can include Ni, Ti, Sn, In, etc.

A conformal film of Si, or any other element or compound, such as Germanium, known to alloy with Li or any other species, is deposited on the CuNW array substrate as illustrated in FIG. 2 and FIG. 3. The deposition of Si can be accomplished by various methods including but not limited to Low Pressure Chemical Vapor Deposition (LPCVD), Plasma Enhanced CVD (PECVD), sputtering, some of which are described in references J. Lee, W. Kim, J. Kim, S. Lim, and S. Lee. Journal of Power Sources 176 (2008) 353-358.; L. F. Cui, R. Ruffo, C. K. Chan, and Y. Cui, NanoLetters, 9, 491-495 (2009).; L. F. Cui, Y. Yang, C. M. Hsu, and Y. Cui, NanoLetters, 9, 3370-3374 (2009).; W. Xu and J. C. Flake, J. Electrochem. Soc. 157(1) A41-A45 (2010).; D. Yu, Y. Xing, Q. Hang, H. Yan, J. Xu, Z. Xi, and S. Feng, Physica E 9 (2001) 305-309.; H. Yang, P. Fu, H. Zhang, Y. Song, Z. Zhou, M. Wu, L. Huang, and G. Xu, Journal of Power Sources 174 (2007) 533-537.; W. Wang, P. N. Kumta, J. Power Sources 172 (2007) 650.; and H. Li, X. Huang, L. Chen, G. Zhou, Z. Zhang, D. Yu, Y. J. Mo, N. Pei, Solid-State Ionics 135 (2000) 181 and references contained therein, all of which are incorporated herein by reference. The CSNC device is a nanostructured substrate coated with a thin film of active material. The nanostructured substrate is a stable platform that is not chemically or physically altered by the deposited film throughout the fabrication or operation of the device.

A thin film of Si on a CuNW array with high surface area enhancement produces a CSNC LIB anode with high energy density.

### BRIEF DESCRIPTION OF THE FIGURES

FIG. 1: Schematic of CuNW array of varying attributes with higher density (left) vs. lower density (right) and larger diameter NW's (top) vs. smaller diameter NW's (bottom). (Not drawn to scale)

FIG. 2: Embodiment 1. Conceptual drawing of the innovation, a) CuNW array as the anode substrate, b) CuNW array with a thin film deposit of conformal silicon, with sufficient open interstitial space in between NW's to accommodate up to 400% volumetric expansion of the Si, c) CuNW array with a thicker film of conformal Si, with less open interstitial space where the Si will experience radial compression as it expands to 400%, and d) SiNW array on Cu with a c-Si core and α-Si shell. (Not drawn to scale) Potential NW array specifications are: Dia approximately 2-900 nm, C-C distance approximately 130-980 nm, NW length approximately 0.1-100 microns.

FIG. 3: Embodiment 2. Schematic of CuNW array as the anode substrate, and the CuNW array with a deposit of silicon completely filling the interstitial space within the array. (Not drawn to scale)

FIG. 4: Embodiment 3. SiNW array grown directly on a copper foil. The NW's are single crystal, polycrystalline, amorphous, or amorphous shell over a crystalline core.

FIG. 5: Cyclic Voltage vs. Capacity (V/mAh)) for Illuminex SiNW based LIB anode.

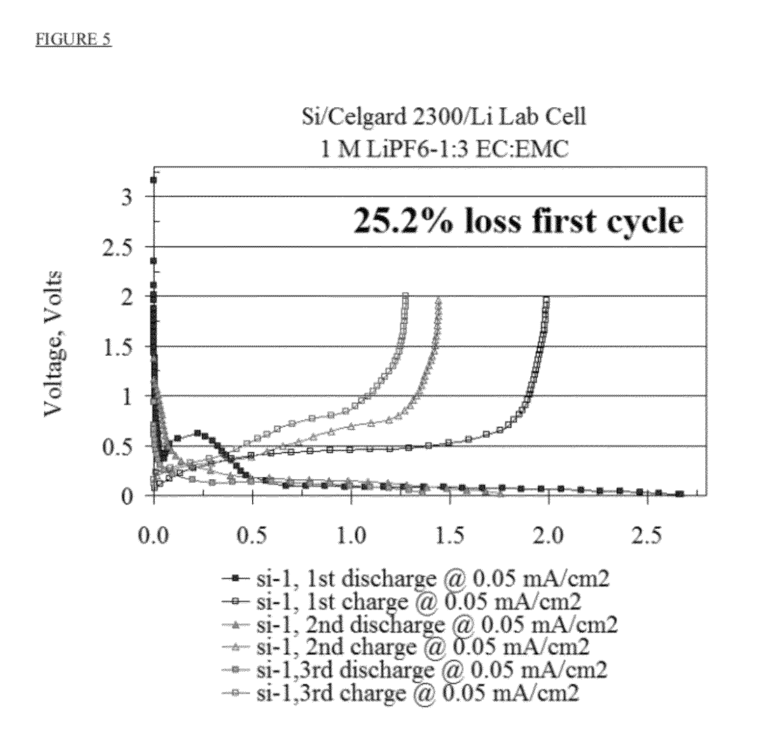

FIG. 6: Process schematic showing the growth of copper nanowires on copper substrates, (Not drawn to scale). Starting with an (a) Al clad Cu sheet, (b) the Al is anodized forming a hexagonal array of pores, AAO, which is then pore widened to make openings completely through to the copper so that (c) nanowires can be plated to the Cu surface filling the pores. (d) The AAO is etched leaving a free-standing CuNW array. (SEM images of the corresponding AAO and NW array.)

FIG. 7: Porous AAO produced in oxalic acid with its respective CuNW array (left) and tartaric acid with its respective CuNW array (right). Oxalic acid produces a higher density of smaller pores, while malonic acid gives larger pores on a larger pitch. The CuNW array produced from the oxalic acid template is higher density than the array produced from the malonic acid template.

FIG. 8: A TEM image of conformal α-Si deposited around a crystalline SiNW core.

FIG. 9: Table 1: AAO parameters vs. Electrolyte.

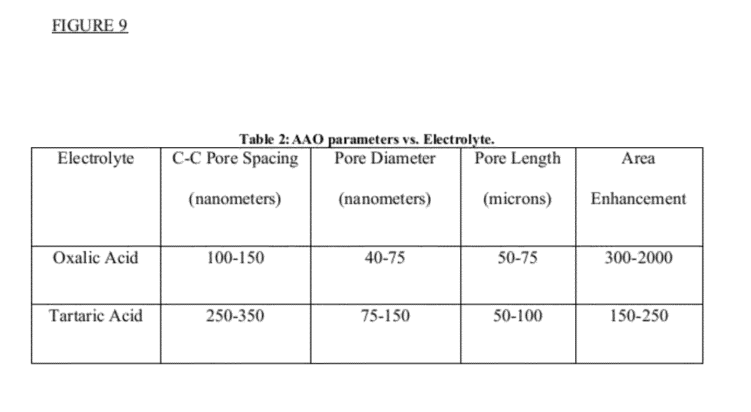

### DETAILED DESCRIPTION OF THE PREFERRED EMBODIMENTS

### Embodiment 1

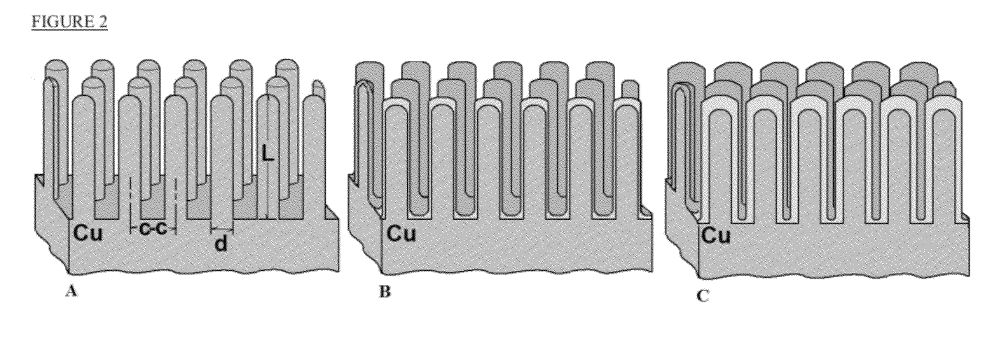

The anode is a copper foil or sheet with a high aspect ratio, high surface area CuNW array on one or both sides, and coated with a conformal film of high capacity Si. The Cu foil with the CuNW array is the substrate providing stable structural support to a conformal film of high capacity Si, and the anode, providing the negative electrical pole for the battery. This anode/electrode design is illustrated in FIG. 2.

The CuNW arrays are produced with NW dia approximately 2-900 nm, center to center (C-C) distance approximately 50-980 nm, NW length approximately 0.1-200 microns as described in Detailed Descriptions of the Preferred Embodiments. The CuNW array substrate is then coated with a conformal film of Si, 1 nm to a maximum thickness less than the one-half the spacing between CuNW's, 2 nm to 300 nm depending on the array specifications, leaving open interstitial volume that is exposed to the battery's electrolyte and can accommodate the expansion of Si as it alloys with Li. To optimize area specific capacity, the NW array properties is balanced between the high surface area enhancement and the interstitial space which allows for thicker Si films and its expansion. The CuNW's provide electrical, thermal, and structural functions to the LIB anode.

### Embodiment 2

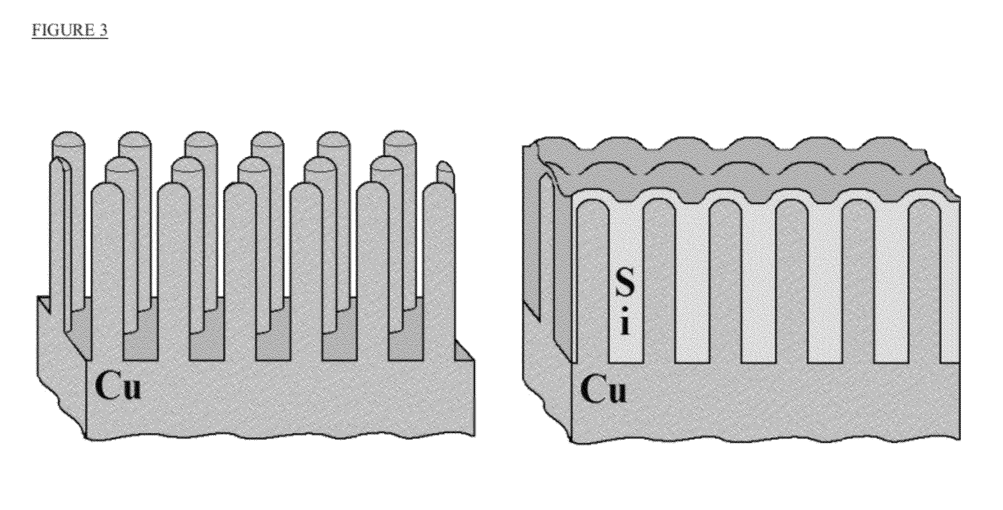

The anode is a copper foil or sheet with a high aspect ratio, high surface area CuNW array on one or both sides which is coated with a conformal film of amorphous or crystalline Si using chemical vapor deposition (CVD) sputter coating or other methods. The Cu foil with the CuNW array is the substrate providing stable structural support to a conformal film of high capacity Si. This anode/electrode design is illustrated in FIG. 3. The CuNW arrays are produced with NW dia approximately 2-900 nm, C-C distance approximately 50-980 nm, NW length approximately 0.1-200 microns as described in Detailed Descriptions of the Preferred Embodiments. The CuNW array substrate is then coated with a conformal film of Si, such that the open area of the array is completely filled with Si as illustrated in FIG. 3. The structure is a thick film of Si, that can be 200 microns thick, on a Cu foil with CuNW's infiltrating the film. The CuNW's provide electrical, thermal, and structural functions to the LIB anode.

In embodiment 1 and embodiment 2, the copper nanowires bound to a Cu foil structurally act as a support for the chemically active silicon film to make anodes with sufficient quantities of Si in a stable form to achieve LIB industrial capacity needs while simultaneously benefiting from the electrical and thermal properties of the copper.

### Embodiment 3

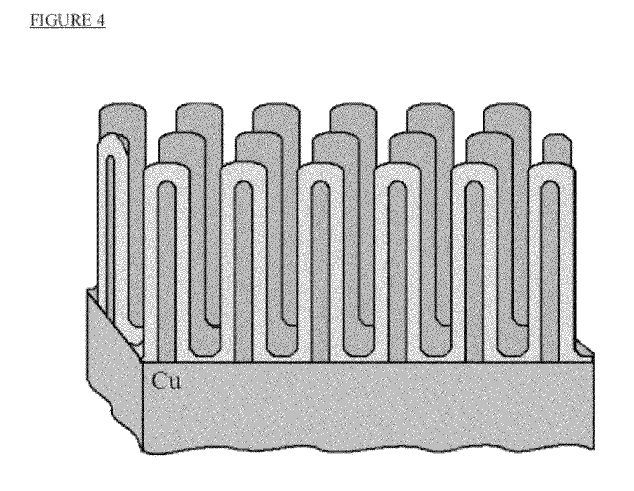

The Cu current collector is a planar Cu foil with an AAO (anodized aluminum oxide) template as a substrate for SiNW growth. This electrode design is illustrated in FIG. 4. Due to the existence of several copper-silicide phases SiNW's can be grown via Vapor-Liquid-Solid (VLS) or Vapor-Solid-Solid (VSS) mechanisms (see: V. Schmidt, J. V. Wittemann, S. Senz, and U. Gosele, Advanced Materials, 21, 2681-2702 [2009]). The AAO template controls the metrics of the SiNW array. The growth of SiNW arrays is described in greater detail in Detailed Descriptions of the Preferred Embodiments. See also U.S. patent application Ser. No. 11/917,505 filed on Dec. 14, 2007, incorporated herein by reference.

An alternative approach is: The Cu current collector is a planar Cu foil without an AAO template as a substrate for SiNW growth. The metrics of the resulting SiNW array is stochastic. This process is described in Detailed Descriptions of the Preferred Embodiments.

In another embodiment SiNW arrays can be produced using an Au catalyst on an AAO on ITO coated ¾×1″ glass substrate. A Cu electrical contact was evaporated on a portion of the SiNW surface.

### The Anode Fabrication Process

a. CuNW Array Process

Illuminex Corporation has developed a method of producing CuNW arrays directly on copper sheet or foil using electrochemical anodizing and plating processes readily scaled to large scale commercial plating techniques for high volume, low cost manufacturing.

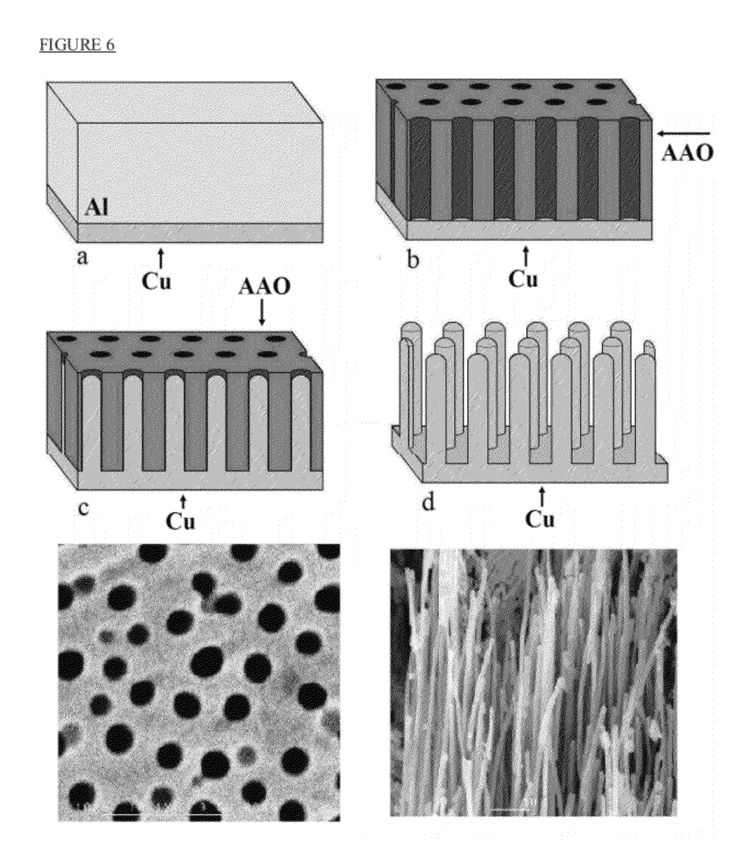

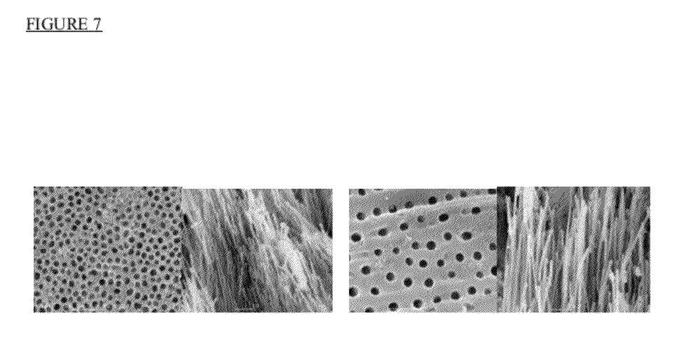

As illustrated in FIG. 6, the CuNW array production starts with copper sheet clad with aluminum (Al) as the precursor material. The entire Al layer is anodized forming a layer of porous anodic aluminum oxide (AAO) directly on the surface of copper sheet. The metrics of the AAO, pore-size, pore-spacing, and thickness, can be controlled by selecting the appropriate process parameters, to create the desired template for the NW array. An example of different AAO templates is given in FIG. 7.

The Cu/AAO substrate is then placed in a copper electro-plating bath and copper is deposited into the pores of the AAO forming CuNW's bonded to the copper substrate. The AAO layer is then entirely chemically removed, leaving a copper sheet with a CuNW array as presented in SEM images contained in FIG. 6 and FIG. 7.

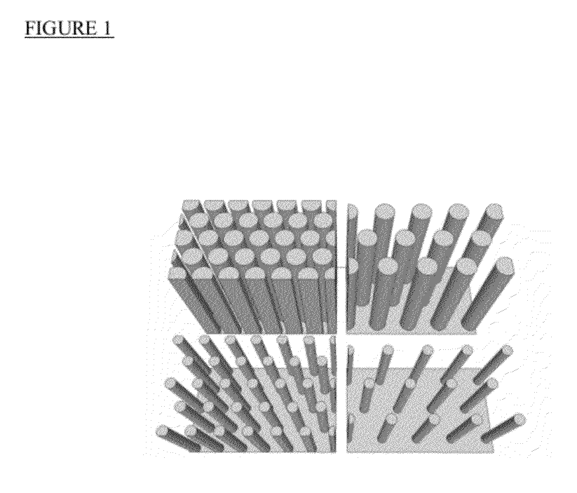

The formation of self-ordered nano-porous (AAO) is a practical and flexible starting material for nano-structure fabrication, largely due to the relative ease of production and the large expanse of dimensions that can be obtained. Pores of AAO, 2-900 nm in diameter, can be controllably produced on center-to-center (C-C) distances of 130-980 nm with NW lengths of 0.1-100 microns: with diameters and C-C distances determined by the type, concentration, temperature and voltage applied to the anodization electrolyte (see: S. Z. Chu, K. Wada, S. Inoue, M. Isogai, Y. Katsuta, and A. Yasumori, J. Electrochem. Soc. 153, B384-B391 [2006]; S. Ono, M. Saito, and H. Asoh, Electrochimca Acta, 51, 827-833 [2005]), with the depths controlled by the initial Al thickness. Depending on the above AAO parameters, CuNW arrays can be produced with nanowire pitch, diameter and length, such that the total surface area of the array can be as much as 10,000 times the area of the planar copper substrate. This range of CuNW arrays is conceptually illustrated in FIG. 1.

b. Silicon Deposition and SiNW Growth.

There are numerous Si deposition methods (see: J. Vossen, W. Kern, “Thin Film Processes”, Academic Press, 1978) available to deposit uniform, conformal Si films of varying thickness and morphology over the CuNW arrays. These include LPCVD, PECVD, dc-rf magnetron sputtering, and other processes that are described in references J. Lee, W. Kim, J. Kim, S. Lim, and S. Lee. Journal of Power Sources 176 (2008) 353-358.; L. F. Cui, R. Ruffo, C. K. Chan, and Y. Cui, NanoLetters, 9, 491-495 (2009).; L. F. Cui, Y. Yang, C. M. Hsu, and Y. Cui, NanoLetters, 9, 3370-3374 (2009).; W. Xu and J. C. Flake, J. Electrochem. Soc. 157(1) A41-A45 (2010).; D. Yu, Y. Xing, Q. Hang, H. Yan, J. Xu, Z. Xi, and S. Feng, Physica E 9 (2001) 305-309.; H. Yang, P. Fu, H. Zhang, Y. Song, Z. Zhou, M. Wu, L. Huang, and G. Xu, Journal of Power Sources 174 (2007) 533-537.; W. Wang, P. N. Kumta, J. Power Sources 172 (2007) 650.; and H. Li, X. Huang, L. Chen, G. Zhou, Z. Zhang, D. Yu, Y. J. Mo, N. Pei, Solid-State Ionics 135 (2000) 181 and references contained therein, all of which are incorporated herein by reference. In the preferred embodiments 1 and 2, the Si deposits conformally over the NW array as illustrated in FIG. 2 or FIG. 3.

As in the preferred embodiment 3, SiNW arrays can be grown directly on Cu or Cu/AAO by VLS and VSS at temperatures typically above 800° C., where copper-silicide phases are formed (V. Schmidt, J. V. Witteman, S. Senz, and U. Gosele, Advanced Materials, 21, 2681-2702 [2009] is incorporated herein by reference). In the case an AAO template is used, the formation of the SiNW's initiates in the pores of the AAO, and the resulting NW metrics will be approximately equivalent to those of the AAO template. Without the template, SiNW growth is stochastic.

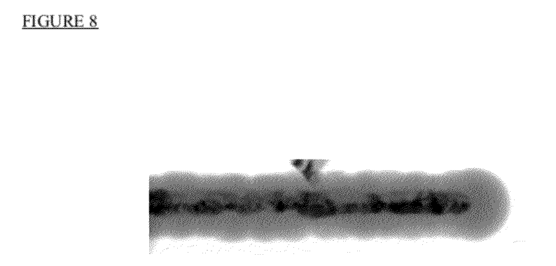

FIG. 8 shows a TEM micrograph of a SiNW with a crystalline (c)-Si core and an amorphous (α)-Si shell prepared in a thermal CVD system. Deposition of α-Si typically occurs as a conformal shell over a c-Si core during the VLS or VSS growth of the SiNW. The amount of conformal α-Si can be increased as preferred by changing the reaction conditions at the appropriate stage in the process to inhibit SiNW growth, and promote conformal Si growth.

### Characterization of the CuNW Array, the Silicon Load, and Electrical Performance.

Methods to characterize the Si coated CuNW arrays, and/or SiNW arrays includes SEM, electron and x-ray diffraction techniques. NW array parameters, diameter, length, C-C spacing, is determined by SEM, and Si structure is determined by diffraction techniques.

The anode performance of the Illuminex CSNC anode is measured by constructing a standard half-cell consisting of coupling the CSNC anodes with lithium metal counter electrodes in a pouch configuration to determine:
1. Mass Specific Capacity—charge per gram, mAh/gm.
2. Specific Energy Density—Charge per total anode mass (electrical conductor+Si, kg)×electrochemical potential approximately 3V for Si anode), Wh/kg.
3. Volumetric Energy Density—Specific Energy Density (Wh/kg)×Anode Density (kg/liter), Wh/liter.
4. Area Specific Capacity—charge per unit area of copper substrate, mAh/cm². This equals “Mass Specific Capacity”×“Silicon Load”. Silicon Load, # of grams Si deposited per unit area of copper substrate, gm/cm², will be determined by SEM imaging and by wet chemical analysis. Volumetric Energy Density=3V×Area Specific Capacity/anode thickness.
5. First cycle loss—the percent change in charge capacity of the electrode after the first charge-discharge cycle.
6. Fade Rate—the percent change in charge capacity of the electrode per charge-discharge cycle.
7. Specific Capacity as a function of C-rate (C-rate is defined as the discharge rate in which a fully charged battery discharges in one hour).

### Calculated Prediction of the Anode Performance

### CuNW Array Metrics:

Performance can be calculated as follows:

NW dia.−80 nm; C-C spacing−200 nm; NW Length−50 microns
NW density−2.9 billion/cm²; NW surface area−1.26×10⁻⁷ cm²
Coated NW circumference=π (Radiusₜₒₜ²−Radius_{CuNW}²)/(Radiusₜₒₜ−Radius_{CuNW})
Area Enhancement=Total CuNW array area/cm² of substrate NW Length×NW Circumference×NW density−580 cm²/cm² of substrate or 580.
Cu foil thickness, without the array, is 0.01 mm, 10 microns, standard thickness for the industry. Total thickness is 60 microns, or 0.006 cm

### Si Film Metrics:

Optimum thickness of Si is the maximum thickness such that there remains adequate interstitial volume to accommodate the 400% film expansion as Si alloys with Li. For the above CuNW array, maximum thickness is 50 nm. The total Si volume contained a square cm of CuNW array density is the number of NW's×(volume of each coated CuNW (Cu+Si) minus volume of each bare CuNW) or Area Enhancement×Si film thickness.

### Calculated Maximum Performance of Silicon Anode

Si Volume=2.9 billion×5000 nm×(π(40+50 nm)²−π(40 nm)²)=0.0029 cc

Or 580 cm²×0.000005 cm=0.0029 cc
Si mass=0.0029 cc×2.3 g/cc=0.0067 g.
Capacity/cm² of Si based anode=4200 mAh/g×0.0067 g=28.0 mAh/cm².
Volumetric Capacity of Si based Anode=1.27×10⁴ Wh/liter assuming a 3V potential.

### Calculated Maximum Performance of Graphite Anode

180 microns thick graphite film on a planar 10 micron Cu foil @ 372 mAh/g. Total thickness=190 microns, or 0.019 cm.

Graphite volume=0.019 cc
Graphite mass=0.019 cc×2.16 g/cc=0.039 g
Capacity/cm² of graphite based anode=372 mAh/g×0.039 g=14.5 mAh/cm².
Volumetric Capacity of graphite based anode=2.28×10³ Wh/liter assuming a 3V potential.

What is claimed:

1. A battery comprised of an anode, said anode comprised of nanowires attached to a conducting substrate that extend away from the substrate.

2. The battery of claim 1 where the nanowires are comprised of Copper and the conducting substrate is comprised of Copper.

3. The battery of claim 1 where the nanowires are comprised of Copper and are coated with a Silicon layer and the substrate is comprised of Copper.

4. The battery of claim 1, 2 or 3 where the substrate is comprised of one of indium, tin, silver, gold, palladium, iron, chromium, titanium, nickel, zinc, cobalt, or lead.

5. A high capacity Lithium Ion Battery anode comprised of nanowires comprised of a layer of Silicon, where the deposited load of Silicon is limited to create an open structure, exposing a high surface area to the battery electrolyte.

6. The anode of claim 5 where the nanowires are comprised of copper and the deposited load of Silicon creating a film with a thickness approximately equal to the length of the CuNW's.

7. A method of making a battery anode comprising the steps of:
Growing nanowires on a conducting substrate.

8. The method of claim 7 further comprising:
Cladding the substrate with an anodized metallic oxide layer that acts as a template to grow the nanowires.

9. The method of claim 8 further comprising:
Growing Copper nanowires;
Coating the Copper nanowires with a layer of Silicon.

10. The method of claim 7 further comprising:
Growing Silicon Nanowires.

11. The method of claim 8 where the Center to Center Pore Spacing is 100-150 nanometers, Pore Diameter 40-75 nanometers and Pore Length 50-75 microns.

12. The method of claim 8 where Center to Center Pore Spacing is 250-350 nanometers, Pore Diameter 75-150 nanometers and Pore Length 50-100 microns.

13. A Lithium Ion battery with an anode, said anode comprised of CuNW arrays as high surface area substrates for deposition of conformal Si, Ge, or other elements that alloys with Li or other elements used as a charge conducting species in the battery electrolyte.

14. A lithium ion battery comprised of an anode that is comprised of Copper nanowires that are attached at one end to a copper substrate and extend into a Silicon layer.

15. The battery of claim 14 where the NW diameter is approximately 2-900 nm, Center to Center distance approximately 50-980 nm and NW length approximately 0.1-200 microns.

16. The battery of claim 14 where the CuNW array substrate is coated with a conformal film of Si, 1 nm to a maximum thickness less than the one-half the spacing between CuNW's, 2 nm to 300 nm, leaving open interstitial volume that is exposed to the battery's electrolyte and can accommodate the expansion of Si as it alloys with Li.
